(19) United States
(12) Patent Application Publication
(10) Pub. No.: US 2019/0031876 A1
(43) Pub. Date: Jan. 31, 2019

(54) TRANSPARENT IMPACT RESISTANT POLYESTER COMPOSITION

(71) Applicant: Far Eastern New Century Corporation, Taipei (TW)

(72) Inventors: Li-Ling CHANG, Taoyuan City (TW); Kuan-Liang WEI, Taoyuan City (TW); Chuan-Hao HSU, Taoyuan City (TW); Chieh-Ling CHEN, Taoyuan City (TW)

(21) Appl. No.: 15/975,795

(22) Filed: May 10, 2018

(30) Foreign Application Priority Data
Jul. 27, 2017 (TW) 106125332

(51) Int. Cl. C08L 67/02

(52) U.S. Cl. CPC C08L 67/02

(57) ABSTRACT

A transparent impact resistant polyester composition is disclosed. The polyester composition comprises 100 parts by weight of polyester, and 0.1 to 6.0 parts by weight of styrene butadiene block copolymer, wherein a molecular weight of the styrene butadiene block copolymer is in the range from 100,000 to 200,000, and an intrinsic viscosity of the styrene butadiene block copolymer is in the range from 0.1 to 0.6.

### CROSS-REFERENCE TO RELATED APPLICATION

This application claims priority to Taiwan Application Serial Number 106125332, filed Jul. 27, 2017, which is herein incorporated by reference.

### BACKGROUND

### Field of Invention

The present invention relates to a polyester composition. More particularly, the present invention relates to an impact resistant polyester composition.

### Description of Related Art

Linear chain polyesters, such as polyethylene terephthalate (PET) and polybutylene terephthalate (PBT), are widely used in a variety of plastic products formed by vacuum-molding or pressure-molding processes because of their outstanding mechanical properties, optical properties and chemical resistance. Illustrative examples of these products include the boxes and containers made of PET films. However, the products are prone to fragmentation due to the collision during the packing and shipping processes. Alternatively, the dropping resistance of the products is poor in an environment at a low temperature. Therefore, the production yield is decreased, and then the manufacturing cost is increased.

In order to improve the impact resistance of the PET at a room temperature and low temperature, an impact modifier is generally added into PET. For example, U.S. Pat. No. 5,041,499 proposed the addition of a high amount (25 wt %-75 wt %) of styrene-butadiene block copolymer (SBC) into the PET which is modified by cyclohexanedimethanol (CHDM). However, a high amount of the modifier may lead to reduced transparency of the polyester products.

In U.S. Pat. No. 5,300,567, it discloses the addition of 10 wt %-40 wt % of the star-shaped SBC into PBT may improve the impact resistance of the plastic film at a low temperature. However, epoxy functional groups are required to be grafted onto the SBC. In addition, while a large of amount of SBC is added into the PBT, the haze of the obtained plastic film is increased and that is unfavorable to the follow-up processing and application.

It is necessary to maintain the transparency of the polyester in some applications. Accordingly, how to improve the impact resistance of the polyethylene terephthalate at a room temperature and low temperature and simultaneously taking its transparency into account is a major issue currently facing.

The impact resistance of PET at a low temperature is poor. In general, PET needs to be modified for the purpose of improving the impact resistance. In prior arts, the toughness of PET may be improved by increasing the intrinsic viscosity (IV) of PET or addition of alcohol or impact modifiers to modify PET in the synthesis process. However, most impact modifiers have to be used in a large amount, and the impact resistance may be merely enhanced to a certain level at a room temperature. At a low temperature, the improvement of the impact resistance is insignificant. In addition, the addition of the impact modifiers in a large amount may result in poor transparency of the polyester products. Furthermore, the usage of the impact modifier in a large amount may decrease the modulus of PET, which causes insufficient stiffness and difficulties of molding.

In prior arts, while PET is unmodified by CHDM, the addition of SBC can not significantly improve the impact resistance thereof. However, using the CHDM-modified PET may cause some recycling issues, make the haze increase, and result in opacity.

In view of the above, the present disclosure provides a polyester composition which improves the impact resistance at both a room temperature and low temperature and takes the transparency of the products into account simultaneously.

### SUMMARY

One aspect of the present disclosure is to provide an impact resistant polyester composition, comprising 100 parts by weight of a polyester obtained from a condensation polymerization of a diol and a dicarboxylic acid and 0.1-6.0 parts by weight of a styrene butadiene block copolymer, wherein the styrene butadiene block copolymer has an intrinsic viscosity of 0.1-0.6, and a weight average molecular weight of the styrene butadiene block copolymer is in the range from 100,000 to 200,000. The styrene butadiene block copolymer comprises styrene units and butadiene units, and a content of the butadiene units is 20 wt %-50 wt % based on a total weight of the styrene butadiene block copolymer.

In accordance with an embodiment of the impact resistant polyester composition of the present disclosure, the diol includes ethylene glycol, 1,2-propanediol, 1,3-propanediol, diethylene glycol, 2,2-dimethyl-1,3-propanediol, 1,3-butanediol, 1,4-butanediol, 1,5-pentanediol, 1,6-hexanediol, 1,3-cyclohexanedimethanol, 1,4-cyclohexanedimethanol or a combination thereof.

In accordance with an embodiment of the impact resistant polyester composition of the present disclosure, the dicarboxylic acid includes terephthalic acid, phthalic acid, 2,6-dicarboxylic acid, 1,5-dicarboxylic acid or a combination thereof.

In accordance with an embodiment of the impact resistant polyester composition of the present disclosure, the polyester includes polyethylene terephthalate.

In accordance with an embodiment of the impact resistant polyester composition of the present disclosure, a polydispersity index of the styrene butadiene block copolymer is greater than 1.2.

In accordance with an embodiment of the impact resistant polyester composition of the present disclosure, a haze of a molding part made of the transparent impact resistant polyester composition is less than or equal to 10. Further, the haze of the molding part is greater than 1.

In accordance with an embodiment of the impact resistant polyester composition of the present disclosure, the transparent impact resistant polyester composition further comprises an additive, wherein an amount of the additive is 0-30 part(s) by weight.

In accordance with an embodiment of the impact resistant polyester composition of the present disclosure, the additive is selected from the group consisting of colorants, antistatic agents, flame retardants, UV stabilizers, slip agents, plasticizers, inorganic fillers, antioxidants, lubricants and a combination thereof.

In accordance with an embodiment of the impact resistant polyester composition of the present disclosure, the styrene butadiene block copolymer has an amount of 1.0-5.0 part(s) by weight.

In accordance with an embodiment of the impact resistant polyester composition of the present disclosure, the styrene butadiene block copolymer has an amount of 1.0-3.0 part(s) by weight.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### DETAILED DESCRIPTION

The present disclosure provides a polyester composition including polyester and a modifier, in which the polyester is obtained from a condensation polymerization reaction of diols and dicarboxylic acids. The modifier may be a styrene butadiene block copolymer (SBC). The molecular weight of the SBC may be from about 100,000 to about 200,000, and an intrinsic viscosity of the SBC may be from about 0.1 to about 0.6.

In one embodiment of the present disclosure, the polyester composition comprises 100 parts by weight of the polyester, and less than or equal to 6 parts by weight of the SBC, such as 0.1, 0.5, 1, 2, 3, 4, 5 and 6, preferably from 1.0 to 5.0 parts by weight, more preferably from 1.0 to 3.0 parts by weight.

The weight average molecular weight (Mw) of the SBC may be from about 100,000 to about 200,000, and the intrinsic viscosity of the SBC may be from about 0.1 to about 0.6, such as 0.1, 0.2, 0.3, 0.4, 0.5 and 0.6.

SBCs can be divided into linear types and non-linear types according to its chemical structures. The non-linear SBCs include, but not limited to, branched SBC, star-shaped SBC, multi-arm SBC and comb-like SBC. After a number of experiments, the inventors have discovered that the star-shaped SBC or the multi-arm SBC may improve the impact resistance of the polyester composition at a low temperature better than the linear SBCs. Specifically, the SBC used in the present disclosure may be the star-shaped type. The core of the star-shaped SBC may be polybutadiene (PB), and the SBC may have polystyrene (PS) arms.

The SBC is a copolymer obtained from the anionic polymerization reaction of styrene and 1,3-butadiene, using butyllithium (BuLi) as an initiator. The difference between the star-shaped SBC and the linear SBCs is the synthesis method. In the polymerization of the star-shaped SBC, multifunctional coupling agent is used, and the molar ratio of the initiator to the coupling agent is adjusted to control the polymerization reaction in order to obtain the star-shaped SBC, in which the number of arms of each star-shaped SBC is the same as the number of the functional groups of the coupling agent.

In another embodiment of the present disclosure, the content of the butadiene units ranges from about 20 wt % to about 50 wt % based on the total weight of the SBC. When the content of the butadiene units is greater than 50 wt %, the compatibility between the SBC and the polyester is relatively poor. When the content of the butadiene units is less than 20 wt %, the improvement of the impact resistance of polyester is not significant enough.

In an embodiment of the present disclosure, the SBC has a polydispersity index of greater than 1.2.

The polyester used in the present disclosure may be obtained from a polymerization reaction of diols and dicarboxylic acids. The diols may be ethylene glycol, 1,2-propanediol, 1,3-propanediol, diethylene glycol, 2,2-dimethyl-1,3-propanediol, 1,3-butanediol, 1,4-butanediol, 1,5-pentanediol, 1,6-hexanediol, 1,3-cyclohexanedimethanol or 1,4-cyclohexanedimethanol. The dicarboxylic acids may be terephthalic acid, phthalic acid, 2,6-dicarboxylic acid or 1,5-dicarboxylic acid.

An appropriate amount of additives, such as colorants, antistatic agents, flame retardants, UV stabilizers, slip agents, plasticizers, inorganic fillers, antioxidants, lubricants and/or a combination thereof, may be added to the polyester composition disclosed in the present disclosure, depending on the demand. Preferably, the additive is added in an amount of 0 to 30 parts by weight, such as 5, 10, 20 or 30 parts by weight, based on that the total weight of the polyester is 100 parts by weight.

In the present disclosure, the polyester composition may be processed to form a polyester sheet by conventional methods. For example, the polyester composition may be fed into a single or double screw extruder, in which the polyester composition is melted at a processing temperature of about 200° C. to about 300° C., and then the melted polyester composition is extruded from a T-die so as to form the polyester sheet.

The polyester composition disclosed herein may be made into various types of products by using a variety of suitable methods, depending on the demand of the subsequent applications.

The table 1 below shows the non-linear SBCs used in the following examples.

TABLE 1

| Brands | Model number |
|---|---|
| NEOS Styrolution | 656C |
| | 684D |
| Chevron Phillips Chemical | KK38 |
| Kraton | DX410JS |

The table 2 below shows the linear SBCs used in the following examples.

TABLE 2

| Brands | Model number |
|---|---|
| Asahi-kasei | Asaflex 825 |
| Taiwan Synthetic Rubber Corp. | Taipol 4202 |

The PET granules used in the following examples are CB600H produced by Far Eastern New Century Corporation.

Test methods used in the following examples are described as following: (1) mechanical properties being measured according to ASTM D638; (2) haze being measured according to ASTM D1003; (3) gel permeation chromatography (GPC) analysis results being obtained by Viscotek 270 dual detector (RALLS-Viscometer) and Shodex RI-72 detector; (4) contents of the butadiene units in the SBCs being analyzed by nuclear magnetic resonance (NMR); and (5) low temperature impact tests of the film being performed according to ASTM D1790.

It is considered that the transparency of the film is acceptable when the haze is less than 10.

As to the low temperature impact test, the sample is prepared at a room temperature and has a width of 50.8 mm and a length of 146.1 mm. The long side is parallel to the textures of the sample. The sample is bent into U-shape and then the opposite ends are bonded with tape.

The processes of the low temperature impact test of the film are described as following: acquiring 10 pieces of samples for each testing group, storing the samples in a constant-temperature freezer at −40° C. for 20 minutes, performing a strike test in the constant-temperature freezer and counting the cracking rate of the 10 pieces of samples. In the following examples, the evaluation results are based on the cracking rate of each testing group, in which
symbol “\textcircled{∘}” represents: cracking rate ≤30%;
symbol “◯” represents: 30%<cracking rate ≤60%;
symbol “Δ” represents: 60%<cracking rate ≤80%; and
symbol “×” represents: cracking rate >80%.

Table 3 shows the in-coming test results of the raw materials (i.e., SBCs), wherein M_{w} is the weight-average molecular weight, Mₙ is the number-average molecular weight, PDI is the polydispersity index, and IV is the intrinsic viscosity.

TABLE 3

| Type | Model number | M_{w} | Mₙ | PDI | IV |
|---|---|---|---|---|---|
| Non-linear | 656C | 162,853 | 100,132 | 1.63 | 0.21 |
| | 684D | 158,484 | 97,221 | 1.63 | 0.24 |
| | KK38 | 137,001 | 75,573 | 1.80 | 0.27 |
| | DX410JS | 108,564 | 69,485 | 1.56 | 0.33 |
| Linear | Asaflex825 | 108,952 | 103,434 | 1.05 | 0.76 |
| | Taipol4202 | 132,516 | 120,469 | 1.10 | 0.74 |

From the GPC analysis above, the PDI results can be used to identify whether the SBCs are linear SBCs or non-linear SBCs. When the PDI is less than or equal to 1.2, the SBCs are linear. When PDI is greater than 1.2, the SBCs are non-linear.

Non-linear SBCs have a lower viscosity than that of linear SBCs under the situation that both SBCs are of similar molecular weights. The molecular weights of the SBCs used in the present disclosure are ranged from 100,000 to 200,000, and therefore the value of viscosity can be used to determine whether the SBCs are linear or non-linear. In the case where the SBC molecular weight are ranged from 100,000 to 200,000, the IV value of less than or equal to 0.6 indicates that the SBC is a non-linear structure, but the IV value of greater than 0.6 indicates that the SBC is a linear structure.

### EMBODIMENTS 1-2, AND COMPARATIVE EXAMPLES 1-2

The 100 parts by weight of the PET granules were put into an oven at 140° C., desiccated for 12 hours, such that the water content of the PET granules was less than 50 ppm. Then, the desiccated PET granules were well mixed with 1 part by weight of the non-linear SBC plastic pellets. The non-linear SBCs with different contents of the butadiene units were used herein. The model numbers and the contents of the butadiene units of the non-linear SBCs are shown in table 4, wherein the content of the butadiene unit is represented as a weight percentage based on the total weight of the respective SBC. The well-mixed granules and non-linear SBC plastic pellets were put into a sheet extruder operating at a temperature of 270° C., wherein the aspect ratio of the screw of the extruder was 28-36. The haze and the low temperature impact cracking rate of the extruded sheets were measured, in which the symbols “\textcircled{∘}” and “◯” in the “cold resistance” column indicate that the low temperature impact cracking rate of the PET films were effectively improved, while the symbols “Δ” and “×” indicate that the low temperature impact cracking rates of the PET films were not effectively improved. The results are shown in table 4.

### COMPARATIVE EXAMPLE 3-4

The 100 parts by weight of the PET granules were put into an oven at 140° C., desiccated for 12 hours, such that the water content of the PET granules was less than 50ppm. Then, the desiccated PET granules were well mixed with 1 part by weight of linear SBC plastic pellets. The linear SBCs with different contents of the butadiene units were used herein. The model numbers and the contents of the butadiene units of the linear SBCs are shown in Table. 4, wherein the content of the butadiene unit is represented as a weight percentage based on the total weight of the respective SBCs. The well-mixed granules and linear SBC plastic pellets were put into a sheet extruder operating at a temperature of 270° C., wherein the aspect ratio of the screw of the extruder was 28-36. The haze and the low temperature impact cracking rate of the extruded sheets were measured, in which the symbols “\textcircled{∘}” and “∘” in the “cold resistance” column indicate that the low temperature impact cracking rate of the PET films were effectively improved, while the symbols “Δ” and “×” indicate that the low temperature impact cracking rates of the PET films were not effectively improved. The results are shown in table 4.

TABLE 4

| | | SBC | | | | | |
|---|---|---|---|---|---|---|---|
| | | | | | Amount | | |
| | | | | Content | of | | |
| | | | | of | addition | | |
| | PET (parts | | | butadiene | (parts | | |
| | by | | Model | units | by | | Cold |
| | weight) | Type | number | (wt %) | weight) | Haze | resistance |
| Comparative | 100 | Non-linear | 656C | 15 | 1 | 2.0 | X |
| Example 1 | | | | | | | |
| Embodiment 1 | | | 684D | 23 | | 2.2 | ⊚ |
| Embodiment 2 | | | KK38 | 38 | | 3.5 | ⊚ |
| Comparative | | | DX410JS | 82 | | 65.5 | X |
| Example 2 | | | | | | | |
| Comparative | | Linear | Asaflex825 | 24 | | 2.5 | Δ |
| Example 3 | | | | | | | |
| Comparative | | | Taipol4202 | 60 | | 49.2 | X |
| Example 4 | | | | | | | |

In Comparative Example 3 and Embodiment 1, the SBCs with similar contents of the butadiene units are added to the PETs. As compared with Embodiment 1, Comparative Example 3 using the linear SBCs is obviously inferior to Embodiment 1 using the non-linear SBCs in terms of the “cold resistance”, and this suggests that the linear SBCs cannot significantly improve the “cold resistance”. It shows that the non-linear SBCs are better than the linear SBCs in view of the improvement to the cold resistance under the same addition amount.

According to the experimental results, the non-linear SBCs with different contents of the butadiene units have different performance in the haze and the cold resistance when the addition amount is 1 part by weight. The haze increases as the content of the butadiene units of the non-linear SBC increases. The inventors have discovered that the non-linear SBCs with the content of the butadiene units ranged from 20 wt % to 50 wt % may induce the PET film with better cold resistance, in which the content of the butadiene units may be 20 wt %, 25 wt %, 30 wt %, 35 wt %, 40 wt %, 45 wt % or 50 wt %. More specifically, the performance of the cold resistance is relatively better when the SBC is a non-linear SBC which has the content of the butadiene units of 20 wt %-50 wt %, such as 20 wt %, 25 wt %, 30 wt %, 35 wt %, 40 wt %, 45 wt % or 50 wt %.

### EMBODIMENT 3-4, COMPARATIVE EXAMPLE 5-6

The 100 parts by weight of the PET granules were put into an oven at 140° C., desiccated for 12 hours, such that the water content of the PET granules was less than 50ppm. Then, the desiccated PET granules were well mixed with 1-12 part(s) by weight of branched SBC plastic pellets. The branched SBC used herein was 684D, NEOS Styrolution, wherein the content of the butadiene units was 23 wt % based on the total weight of the branched SBC. The well-mixed granules and branched SBC plastic pellets were put into a sheet extruder operating at a temperature of 270° C., wherein the aspect ratio of the screw of the extruder was 28-36. The haze and the low temperature impact cracking rate of the extruded sheets were measured, in which the symbols “\textcircled{∘}” and “◯” in the “cold resistance” column indicate that the low temperature impact cracking rate of the PET films were effectively improved, while the symbols “Δ” and “×” indicate that the low temperature impact cracking rates of the PET films were not effectively improved. The results are shown in table 5.

### COMPARATIVE EXAMPLE 7

The PET granules were put into an oven at 140° C., desiccated for 12 hours, such that the water content of the PET granules is less than 50 ppm. The PET granules were put into a sheet extruder operating at a temperature of 270° C., wherein the aspect ratio of the screw of the extruder was 28-36. The haze and the low temperature impact cracking rate of the extruded sheets were measured, in which the symbols “\textcircled{∘}” and “◯” in the “cold resistance” column indicate that the low temperature impact cracking rate of the PET films were effectively improved, while the symbols “Δ” and “×” indicate that the low temperature impact cracking rates of the PET films were not effectively improved. The results are shown in table 5.

TABLE 5

| | | SBC | | | |
|---|---|---|---|---|---|
| | | | Amount of | | |
| | PET | | addition | | |
| | (parts by | Model | (parts by | | Cold |
| | weight) | number | weight) | Haze | resistance |
| Embodiment 1 | 100 | 684D | 1 | 2.2 | ⊚ |
| Embodiment 3 | | | 3 | 5.6 | ⊚ |
| Embodiment 4 | | | 5 | 9.0 | ◯ |
| Comparative | | | 8 | 11.5 | Δ |
| Example 5 | | | | | |
| Comparative | | | 12 | 15.2 | X |
| Example 6 | | | | | |
| Comparative | | | 0 | 2.5 | X |
| Example 7 | | | | | |

According to the results in table 5, when the addition amounts of the SBC is ranged from 1 to 5 part(s) by weight, the PET sheets possess a better performance on the cold resistance at a low temperature. In particular, when 1-3 part(s) by weight of the SBC is added, the cold resistance and the transparency are relatively better. On the other hand, when the amount of the SBC is greater than 5 parts by weight, the cold resistance of the PET can not be significantly improved, and the haze thereof significantly increases and causes opaque.

In addition, from the result of Comparative Example 7, the films made of the PET which is not modified by the SBCs seriously crack at a low temperature (−40° C.) and the cold resistance is poor. It shows that the PET modified by the SBCs disclosed herein can considerably increase the cold resistance.

In view of the above, the present disclosure provides a transparent and impact resistant polyester composition. By means of adding the non-linear SBCs, the obtained polyester sheet has great transparency and excellent cold resistance.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An impact resistant polyester composition, comprising:
100 part(s) by weight of a polyester, wherein the polyester is obtained from a condensation polymerization of a diol and a dicarboxylic acid; and
0.1-6.0 part(s) by weight of styrene butadiene block copolymer, having an intrinsic viscosity 0.1-0.6, wherein a weight-average molecular weight of the styrene butadiene block copolymer is between 100,000 and 200,000, and the styrene butadiene block copolymer comprises styrene units and butadiene units, a content of the butadiene units is 20 wt %-50 wt % based on a total weight of the styrene butadiene block copolymer.

2. The impact resistant polyester composition of claim 1, wherein the diol comprises ethylene glycol, 1,2-propanediol, 1,3-propanediol, diethylene glycol, 2,2-dimethyl-1,3-propanediol, 1,3-butanediol, 1,4-butanediol, 1,5-pentanediol, 1,6-hexanediol, 1,3-cyclohexanedimethanol, 1,4-cyclohexanedimethanol or a combination thereof.

3. The impact resistant polyester composition of claim 1, wherein the dicarboxylic acid comprises terephthalic acid, phthalic acid, 2,6-dicarboxylic acid, 1,5-dicarboxylic acid, or a combination thereof.

4. The impact resistant polyester composition of claim 1, wherein the polyester comprises polyethylene terephthalate.

5. The impact resistant polyester composition of claim 1, wherein a polydispersity index of the styrene butadiene block copolymer is greater than 1.2.

6. The impact resistant polyester composition of claim 1, wherein a haze of a molding part made of the impact resistant polyester composition is less than or equal to 10.

7. The impact resistant polyester composition of claim 1, further comprising an additive, wherein an amount of the additive is 0-30 part(s) by weight.

8. The impact resistant polyester composition of claim 7, wherein the additive is selected from the group consisting of colorants, antistatic agents, flame retardants, UV stabilizers, slip agents, plasticizers, inorganic fillers, antioxidants, lubricants and a combination thereof.

9. The impact resistant polyester composition of claim 1, wherein the styrene butadiene block copolymer has an amount of 1.0-5.0 part(s) by weight.

10. The impact resistant polyester composition of claim 1, wherein the styrene butadiene block copolymer has an amount of 1.0-3.0 part(s) by weight.
